(19) United States
(12) Patent Application Publication
(10) Pub. No.: US 2005/0205749 A1
(43) Pub. Date: Sep. 22, 2005

(54) Fiber mesh reinforced elastomeric vibration isolation pads

(76) Inventor: Scott Douglass Campbell, Lewis Center, OH (US)

Correspondence Address: Kathleen K. Bowen Co., LPA, 311 Hillbrook Dr, Cuyahoga Falls, OH, 44223, US

(21) Appl. No.: 10/970,375

(22) Filed: Oct. 21, 2004

Related U.S. Application Data
(60) Provisional application No. 60/513,102, filed on Oct. 21, 2003.

(51) Int. Cl. F16M 11/20; A47B 91/00

(52) U.S. Cl. 248/633

(57) ABSTRACT

A vibration isolation pad comprises at least two layers of elastomeric material, and at least 1 layer of fiber mesh. The fiber mesh is encapsulated between the layers of elastomeric material, and cured to form an elastomeric/fiber mesh/elastomeric laminate, thus producing a thinner, more flexible, lower cost vibration isolation pad.

This application claims the benefit of U.S. Provisional Application No. 60/513,102, filed Oct. 21, 2003.

### BACKGROUND

Multiple markets demand engineered vibration isolation pads. Applications in building and track-bed isolation, architectural, industrial, and HVAC use elastomeric pads to provide vertical vibration isolation.

The design of laminated bearing pads is a complex undertaking. The size of the pad, number and thickness of elastomeric layers, durometer of the elastomer, and reinforcing thickness all need to be determined. Several, often conflicting, design criteria must be satisfied; including limitations on the pad size, total pad thickness, natural frequency at the design load, appropriate safety factors when overloaded, and changes in properties under long term, or cyclical loads. In many instances, the amount of vibration isolation provided is limited by the stability of the pads as their height increases.

Current state of the art for vibration isolation pads uses steel shims between layers of rubber to reduce bulging and provide stability. Typical building isolation pads have alternating layers of rubber and steel plates that are vulcanized together. The steel plates, although a minor part of the pad thickness, account for about one-half of the total weight. In addition, pads produced this way are expensive in large part due to the labor involved in preparing the steel plates, which are cut, sand blasted, acid cleaned, and then coated with bonding compound. The need to highly process the plates also results in a plate thickness much larger than required to provide confinement to the rubber. These pads also provide no flexibility in application. Each pad must be pre-formed to the required dimensions of the project. Further, because the bond between the metal shims and the rubber is mainly a chemical bond, there is a danger of delamination over time.

A vibration isolation pad is desired which will have stability at greater thicknesses, and be flexible in application, so as to be able to be cut to size in the field. Further, a vibration isolation pad is desired which can obtain lower vibration frequencies for a given pad height, thus allowing use of thinner vibration isolation pads for a given frequency. Further, a lower cost vibration isolation pad is desired, with reduced threat of delamination over time. Further, a vibration isolation pad is desired that is non-magnetic.

### SUMMARY OF THE INVENTION

A vibration isolation pad comprises at least two layers of elastomeric material, and at least 1 layer of fiber mesh. The fiber mesh is encapsulated between the layers of elastomeric material, and cured to form an elastomeric/fiber mesh/elastomeric laminate, thus producing a thinner, more flexible, lower cost vibration isolation pad.

### BRIEF DESCRIPTION OF THE DRAWINGS

FIG. 1 is an isometric exploded view of a vibration isolation pad according to an aspect of the invention.

FIG. 2 is an isometric view of a vibration isolation pad according to an aspect of the invention.

FIG. 3 is an isometric view of a vibration isolation pad according to an aspect of the invention.

FIG. 4 is an isometric view of a vibration isolation pad according to an aspect of the invention.

FIG. 5 is an installed view of a vibration isolation pad according to an aspect of the invention.

### DETAILED DESCRIPTION

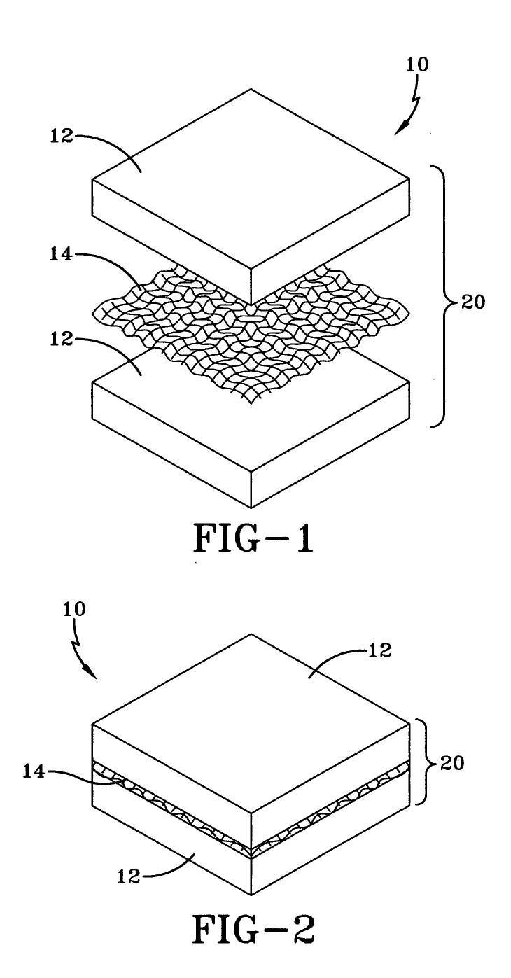

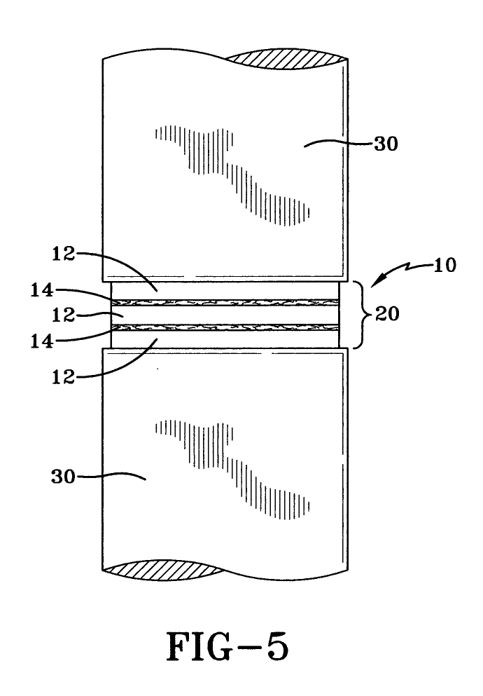

Various aspects of the invention are presented in FIGS. 1-5 which are not drawn to scale and in which like components are numbered alike. Referring now to FIGS. 1-5, according to an aspect of the invention, a vibration isolation pad 10 comprises at least two layers of elastomeric material 12, and at least 1 layer of fiber mesh 14, wherein the fiber mesh 14 is encapsulated between the layers of elastomeric material 12, and cured to form an elastomeric/fiber mesh/elastomeric laminate 20. Using fiber mesh instead of steel shims results in a lighter pad that can be easily cut to size. Further, for application as vibration isolation pads, the pad reinforcement must have sufficient strength and stiffness to support the loads, eliminating current flexible pad reinforcement from consideration. Different pad properties are required for vibration isolation as compared to other, similar applications such as bridge bearings. In addition, lower frequencies can be obtained for a given pad height, thus thinner pads can be used for a given frequency. Further, using fiber mesh instead of steel shims results in both a chemical and mechanical bond between layers thus reducing the likelihood of delamination over time.

Because of the complex design criteria for bearing pads, an analytical model of the bearing pads is necessary to understand bearing pad behavior in use, and therefore correctly design these pads. An analytical model for steel reinforced elastomeric pads is a relatively simple matter due to the rigid restraint the metal shims put on the pad movement. Using a fiber mesh reinforced elastomeric pad is a more complex analytical problem, since the fiber mesh can deform along with the elastomer.

An analytical model was developed, and subsequently tested by experimentation, both of which are detailed in a paper presented to “The 33^{rd} International Congress and Exposition on Noise Control Engineering” by the inventor. This paper is hereby incorporated by reference, in its entirety. This testing showed that fiber mesh reinforced vibration isolation pads provide performance similar to conventionally reinforced pads, and that their operation meets current specifications. This analytical model allows design of fiber mesh reinforced vibration isolation pads for each specific application, thus determining the thickness of the elastomer layers, and the overall elastomer/mesh/elastomer thickness, as well as number of layers, to be determined on an application specific basis.

This new vibration isolation pad can be used for building and rail-trackbed isolation, seismically isolated floors, equipment isolation for the power generation industry, stamping, and other heavy industrial equipment, as well as HVAC equipment isolation when springs cannot be used. These are just some of the many potential applications.

According to a further aspect of the invention, the elastomeric material 12 is neoprene. According to another aspect of the invention, the elastomeric material 12 is natural rubber.

In a preferred embodiment of the invention, the fiber mesh 14 is comprised of woven carbon (graphite) fibers.

According to a further aspect of the invention, the layers of elastomeric material 12 and fiber mesh 14 are stacked such that there are multiple layers of each of the elastomeric material 12 and the fiber mesh 14, see FIG. 4.

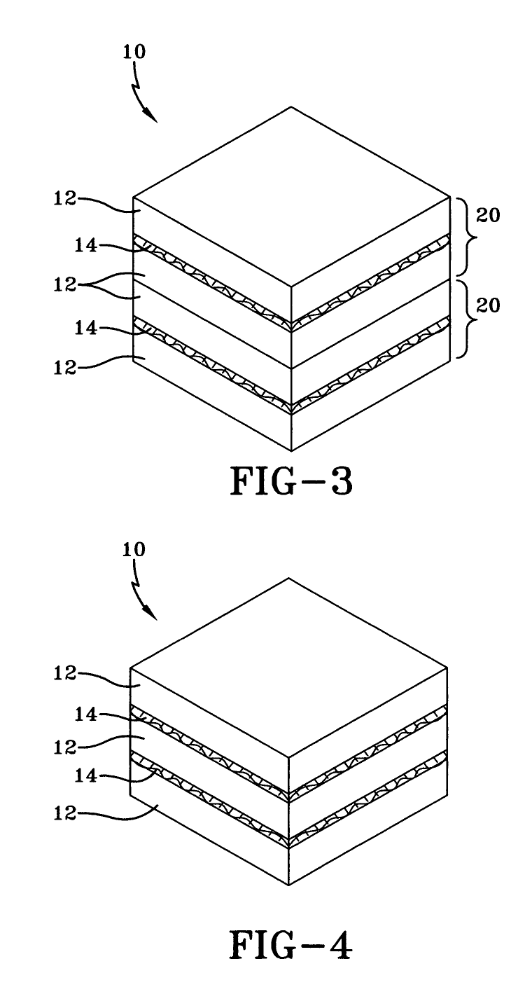

According to another aspect of the invention, a method for making a vibration isolation pad 10 comprises the steps of layering elastomeric material 12 and fiber mesh 14, such that the fiber mesh 14 is encapsulated by the elastomeric material 12, and then curing the layers to form an elastomeric/fiber mesh/elastomeric laminate 20. According to design specifications, multiple elastomeric/fiber mesh/elastomeric laminates 20 may be stacked and cured together, forming the thickness of vibration isolation pad required for the application, see FIG. 3.

According to a further aspect of the invention, there is a method for vibrationally isolating two objects 30 which method comprises the steps of curing a laminate of at least one layer of fiber mesh 14 encapsulated by at least two layers of elastomeric material 12, and then placing the laminate 20 between the objects to be isolated from one another, such that each object is in pressure contact with the laminate 20. Besides the multilayered laminate described above, if additional thickness is needed in the field, multiple vulcanized multiple elastomeric/fiber mesh/elastomeric laminates 20 may be stacked together.

In a further embodiment, additional materials, such as a mounting plate, are placed between the objects to be isolated.

1. A vibration isolation pad comprising;
at least two layers of elastomeric material; and,
at least 1 layer of fiber mesh, wherein said fiber mesh is encapsulated between said layers of elastomeric material, and cured to form an elastomeric/fiber mesh/elastomeric laminate.

2. The vibration isolation pad of claim 1 wherein said elastomeric material is neoprene.

3. The vibration isolation pad of claim 1 wherein said elastomeric material is natural rubber.

4. The vibration isolation pad of claim 1 wherein said fiber mesh is comprised of woven carbon (graphite) fibers.

5. The vibration isolation pad of claim 1 wherein said layers are stacked such that there are multiple elastomeric/fiber mesh/elastomeric laminates.

6. A method for making a vibration isolation pad, comprising the steps:
layering elastomeric material and fiber mesh, such that said fiber mesh is encapsulated by said elastomeric material; and,
curing said elastomeric material and fiber mesh to form an elastomeric/fiber mesh/elastomeric laminate.

7. The method of claim 6 wherein multiple elastomeric/fiber mesh/elastomeric laminates are stacked and cured together.

8. A method for vibrationally isolating two objects, comprising the steps:
curing a laminate of at least one layer of fiber mesh encapsulated by at least two layers of elastomeric material; and,
placing said laminate between the objects to be isolated from one another, such that each object is in pressure contact with said laminate.

9. The method of claim 8 wherein additional materials are placed between the objects to be isolated.

10. The method of claim 8 wherein said fiber mesh is comprised of woven carbon (graphite) fibers.
